(19) United States
(12) Patent Application Publication
(10) Pub. No.: US 2015/0206226 A1
(43) Pub. Date: Jul. 23, 2015

(54) SYSTEMS AND METHODS FOR COORDINATING INFORMATION TRANSFER

(71) Applicant: JKF Consulting, Inc., Hillsboro, OR (US)

(72) Inventor: Jennifer K. Flanagan, Hillsboro, OR (US)

(21) Appl. No.: 14/599,204

(22) Filed: Jan. 16, 2015

Related U.S. Application Data
(60) Provisional application No. 61/929,279, filed on Jan. 20, 2014.

(51) Int. Cl. G06Q 30/06; G06Q 30/02

(52) U.S. Cl. CPC G06Q 30/0633; G06Q 30/0635; G06Q 30/0253

(57) ABSTRACT

Methods for coordinating information transfer. The methods may include methods of coordinating information transfer among a plurality of entities. These methods may include obtaining list data for an equestrian activity from an influencer, providing the list data to a customer, and providing supply-side data to a supply-side entity. The list data includes a list of equestrian equipment for the equestrian activity and the supply-side data is based, at least in part, on the influencer and on the list data. The methods additionally or alternatively may include methods of providing targeted information from a supply-side entity. These methods may include obtaining supply-side data for an equestrian activity from a list facilitator and performing a supply-side action based, at least in part, on the supply-side data.

### RELATED APPLICATION

This application claims priority to U.S. Provisional Patent Application No. 61/929,279, which was filed on Jan. 20, 2014, and the complete disclosure of which is hereby incorporated by reference.

### FIELD OF THE DISCLOSURE

The present disclosure relates to coordinating information transfer.

### BACKGROUND OF THE DISCLOSURE

The equestrian riding industry is very event focused. Stables offer private lessons, group lessons, weekend camps, summer camps, etc. Children and adults often learn to ride in order to participate in shows and other events. For example, there are jumping events, dressage events, endurance riding events, reining events, western events, gaming events, and vaulting events, to name a few. The equestrian riding industry also requires a significant amount of equipment and clothing, typically the responsibility of individual riders or the parents and guardians of individual riders. Coordinating equestrian riding events often requires communicating to participants the identification of very specific equipment and clothing that is required in order to qualify for, or otherwise be permitted to participate in, an event. Furthermore, many events have different requirements. Accordingly, it can be very frustrating to event participants, and the parents and guardians of child participants, to ensure that all of the correct equipment and clothing is obtained prior to an event and/or brought to the event.

The subject matter disclosed herein is not limited to the equestrian riding industry and may be utilized in any suitable industry in which coordinating information transfer, such as by coordinating lists associated with preferred and/or required items for an activity, is desired. Examples include school supplies for a particular class or grade, sports classes or leagues, competitions, events, hobby clubs, etc. Thus, there exists a need for improved systems and methods for coordinating information transfer.

### SUMMARY OF THE DISCLOSURE

Methods for coordinating information transfer are disclosed herein. The methods may include methods of coordinating information transfer among a plurality of entities. These methods may include obtaining list data for an equestrian activity from an influencer, providing the list data to a customer, and providing supply-side data to a supply-side entity. The list data includes a list of equestrian equipment for the equestrian activity and the supply-side data is based, at least in part, on the influencer and on the list data.

The methods additionally or alternatively may include methods of providing targeted information from a supply-side entity. These methods may include obtaining supply-side data for an equestrian activity from a list facilitator and performing a supply-side action based, at least in part, on the supply-side data. The supply-side data may be based, at least in part, on an influencer and on list data that is compiled by the influencer. The list data includes a list of equestrian equipment, for an equestrian activity, that is recommended to a customer by the influencer.

### BRIEF DESCRIPTION OF THE DRAWINGS

FIG. 1 is a schematic diagram representing systems, according to the present disclosure, for coordinating information transfer.

FIG. 2 is a flowchart schematically representing more specific examples of interactions and/or types of information that may be transferred utilizing the systems and methods according to the present disclosure.

FIG. 3 is an example of a webpage that may be associated with a system and/or method for facilitating lists according to the present disclosure.

FIG. 4 is a flowchart depicting methods, according to the present disclosure, of coordinating information transfer among a plurality of entities.

FIG. 5 is a flowchart depicting methods, according to the present disclosure, of providing targeted information from a supply-side entity.

### DETAILED DESCRIPTION AND BEST MODE OF THE DISCLOSURE

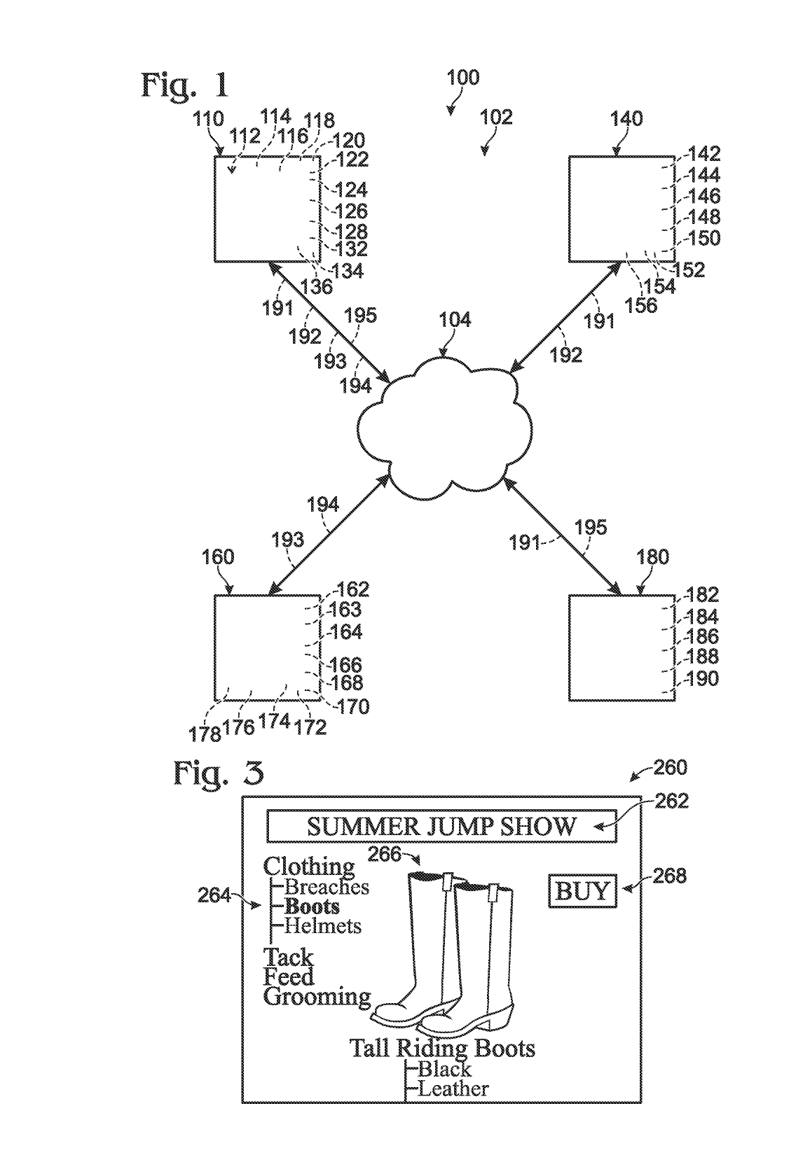

FIGS. 1-5 provide examples of computer and/or network systems 100 according to the present disclosure, of components of computer and/or network systems 100 and/or of methods 200, 300, and/or 400 according to the present disclosure. Elements that serve a similar, or at least substantially similar, purpose are labeled with like numbers in each of FIGS. 1-5, and these elements may not be discussed in detail herein with reference to each of FIGS. 1-5. Similarly, all elements may not be labeled in each of FIGS. 1-5, but reference numerals associated therewith may be utilized herein for consistency. Elements, components, and/or features that are discussed herein with reference to one or more of FIGS. 1-5 may be included in and/or utilized with any of FIGS. 1-5 without departing from the scope of the present disclosure.

In general, elements that are likely to be included in a given (i.e., a particular) embodiment are illustrated in solid lines, while elements that are optional to a given embodiment are illustrated in dashed lines. However, elements that are shown in solid lines are not essential to all embodiments, and an element shown in solid lines may be omitted from a given embodiment without departing from the scope of the present disclosure.

The present disclosure relates to coordinating information transfer, such as lists that may be associated with preferred and/or required items for an activity. More specifically, disclosed herein are computer and/or network systems 100 and methods 200/300/400 that may be implemented at least in part by a system 100 according to the present disclosure. FIG. 1 schematically represents example systems 100, including a computer network 102 associated with a communication infrastructure 104, such as the Internet, for communication and/or exchange of data between two or more of a list facilitator 110, an influencer 140, a customer 160, and/or a supply-side entity 180.

In FIG. 1, list facilitator 110 may include and/or be an electronic device 112, and influencer 140, customer 160, and/or supply-side entity 180 may be separate, distinct, and/or different individuals, entities, and/or corporations that may have corresponding electronic devices 142, 162, and/or 182, respectively, that may communicate with list facilitator 110, such as via communication infrastructure 104. As an example, and when performing one or more steps of methods 200, 300, and/or 400 according to the present disclosure, influencer 140, customer 160, and/or supply-side entity 180 may input information into corresponding electronic device(s) 142, 162, and/or 182. In addition, the corresponding electronic device(s) also may display relevant information to the influencer, to the customer, and/or to the supply-side entity. However, this is not required, and it is within the scope of the present disclosure that one or more communications may be performed in an alternative manner, such as via distribution of hard (printed) copies of information.

The electronic devices, when utilized, may include and/or be any suitable electronic device that may include a user interface for receiving and/or displaying information. Examples of electronic devices according to the present disclosure include servers, desktop computers, laptop computers, mobile electronic devices, tablet computers, handheld electronic devices, and/or cellular/smart phones. Such electronic devices may receive and/or display information via any suitable computer program, program code, web site, web interface, and/or mobile application.

As a more specific example, and as discussed in more detail herein, influencer 140 may receive a list of available products 191 via communication infrastructure 104, with the list of available products being provided by list facilitator 110 and/or by supply-side entity 180. Influencer 140 then may select, from the list of available products, a list of selected products 192 for a given activity and may provide the list of selected products to list facilitator 110. List facilitator 110 then may combine the list of selected products with additional info nation regarding the given activity to generate list data 193 and may provide the list data to customer 160. The customer may utilize the list data to select one or more product(s) for purchase and may provide a purchase order 194 to list facilitator 110. The list facilitator then may (directly or indirectly) convey the one or more product(s) for purchase to the customer. In addition, the list facilitator also may generate supply-side data 195 and provide the supply-side data to supply-side entity 180.

List of available products 191 may include and/or be any suitable list that may include and/or indicate one or more products that may be available for purchase. As an example, the list of available products may include a list of equestrian equipment. As additional examples, list of available products 191 may include and/or be a printed list, a printed catalog, an electronic catalog, and/or a web site that lists, displays, and/or otherwise presents available products for review and/or selection by influencer 140. It is within the scope of the present disclosure that list of available products 191 may include and/or be a single, compiled, and/or discrete list of available products. Alternatively, it is also within the scope of the present disclosure that list of available products 191 may include and/or be a plurality of separate and/or discrete lists, each of which may include one or more available products. As used herein, the phrases “available product” and “available products” may include any and/or all products that may be available in the marketplace, may be available for retail sale to influencer 140 and/or to customer 160, and/or may be marketed, distributed, and/or sold by supply-side entity 180.

List of selected products 192 may include and/or be a portion of the list of available products that has been chosen, indicated, and/or selected by influencer 140. Thus, the list of selected products may include and/or be a subset of the list of available products.

List data 193 may include the list of selected products. In addition, the list data also may include one or more of a list of acceptable parameters for at least one of the selected products, a name of at least one of the selected products, a category of at least one of the selected products, a size of at least one of the selected products, an available size range of at least one of the selected products, a selected style of at least one of the selected products, one or more features or characteristics of at least one of the selected products, a selected color of at least one of the selected products, and/or a selected design of at least one of the selected products. Additionally or alternatively, the list data also may include information regarding the given activity, a location of the given activity, an identity of the influencer, and/or information that correlates the list of selected products to the identity of the influencer.

Purchase order 194 may include any suitable information that may, or may be utilized to, indicated which product(s) from the list of selected products have been selected and/or chosen by the customer. As examples, the purchase order may include a name of one or more products from the list of selected products, a model number of one or more products from the list of selected products, a size of one or more products from the list of selected products, a color of one or more products from the list of selected products, a style of one or more products from the list of selected products, one or more selected features or characteristics of at least one of the selected products, and/or a design of one or more products from the list of selected products. In addition, the purchase order additionally or alternatively may include one or more additional products that were not on the list of selected products. As an example, and as discussed in more detail herein, the systems and methods according to the present disclosure may be utilized to provide targeted marketing to the customer, such as to encourage the customer to purchase one or more products in addition to products that are on the list of selected products and/or to encourage the customer to purchase a higher (or different) quality product than those that are on the list of selected products.

Supply-side data 195 may include any suitable data and/or information that may be based, at least in part, on list data 193, may be based, at least in part, on purchase order 194, may be based, at least in part, on activities of customer 160 while customer 160 is interacting with list facilitator 110 and/or generating purchase order 194, and/or may be provided to supply-side entity 180 by list facilitator 110. As discussed in more detail herein, supply-side entity 180 may utilize supply-side data 195 to make specific and/or targeted decisions regarding (or have specific and/or target interactions with) influencer 140 and/or customer 160. Supply-side data 195, at least when transmitted or otherwise provided to supply-side entity 180, may be anonymized such that the supply-side entity is not provided with an identity of the customer, an identity of the participant, and/or an identity of the influencer. As an example, the list facilitator 110 may anonymize all or a portion of the supply-side data before the data is transmitted or otherwise provided to the supply-side entity 180 or others.

Examples of supply-side data 195 include an identity of influencer 140, list of available products 191, list of selected products 192, list data 193, sales of at least one product from the list of selected products that were generated via providing the list of selected products to the customer, web site hit data for at least one product from the list of selected products that was generated via providing the list of selected products to the customer, related sales information for at least one product that is not on the list of selected products but that was sold as a result of the list of selected products being provided to the customer, related sales information for at least one product that was sold because of the influencer, and/or web site hits data for at least one product that was generated because of the influencer. Any and/or all of the information contained within the supply-side data may be correlated to (or may provide the supply-side entity with) the identity of the influencer.

Additionally or alternatively, the supply-side data also may include a cross-correlation of the list data. As examples, the cross-correlation may group the list data by geographic location, may compare various geographic locations, may group the list data by activity type, may group the list data by gender of the event participant, may compare list data for different event participant genders, may group the list data by age of the event participant, and/or may compare list data for different ages of event participants. As discussed, the supply-side data may be anonymized. Similarly, any cross-correlation of the supply-side data additionally or alternatively may be anonymized, such as by the list facilitator.

A list facilitator 110 includes electronic device 112 and may be associated with and/or be a person and/or organization that facilitates one or more lists on behalf of influencers 140. More specifically, a list facilitator according to the present disclosure may provide a website, through which influencers may manage one or more lists associated with one or more activities. In some systems 100 and methods 200/300/400, the list facilitator may coordinate with, or otherwise interact with and/or provide data to, supply-side entity 180, such as to facilitate customers' purchases of appropriate items identified in list of selected products 192.

As used herein, an influencer 140 is a person or organization that operates, manages, offers, and/or otherwise facilitates an activity for which participants in the activity typically are required to provide certain items for the activity. An influencer additionally or alternatively may be referred to or described as a list manager 140. For purposes of illustration, the equestrian riding industry is used as an example herein, but the present disclosure is not limited to the equestrian riding industry, and the systems and methods disclosed herein may be implemented in any suitable industry and for any suitable activities. As an example, an influencer may be, or may be associated with, an equestrian event, and the corresponding customers may be the equestrian riders that enter, or otherwise intend to participate in, the event. In other words, the equestrian riding event is an example of an activity for which systems and methods according to the present disclosure may be implemented. Other examples of influencers 140 include an activity leader 144, a coordinator 146 of the activity, an expert 148 in the activity, a rules body 150 for the activity, a trainer 152 for a participant in the activity and/or for customer 160, a barn manager 154 associated with the participant in the activity and/or with customer 160, and/or an equestrian club manager 156 associated with the participant in the activity and/or with customer 160. Examples of activities within the equestrian riding industry are discussed herein and include (but are not limited to) summer camps, weekend camps, private lessons, group lessons, etc.

Typically, an equestrian show or event requires significant time and effort to manage, at least in part due to the number of distinct individual events, or competitions, associated therewith. For example, there may be jumping events, dressage events, endurance riding events, reining events, and/or vaulting events, to name a few. Within each of these events, there may be subcategories, such as associated with age groups and/or skill levels. Moreover, the show coordinator, who may be influencer 140, may require that each participant within a single event wear specific clothing items and/or utilize specific equipment. A participant arriving at the show without the proper clothing and/or equipment may not be permitted to participate. Accordingly, for participants that have trained long hours and spent considerable time, effort, and money preparing for a show, being denied admission can be problematic. Similarly, having to deny admission to a participant by a show coordinator also is frustrating, but the safety of the participants, as well as the presentation of the show to the attendees, may be a very important aspect of the show coordinator's duties.

Customer 160 may include any suitable person, group of people, and/or entity that may, may desire to, and/or may be directed to purchase one or more items from list of selected products 192. Thus, customer 160 may be a (direct and/or indirect) customer of supply-side entity 180, since supply-side entity 180 may market, manufacture, distribute, and/or sell at least one item from the list of selected products. Examples of customer 160 include any suitable consumer or purchaser 163, student 164 (including a student of influencer 140 and/or an equestrian student of influencer 140), person 166 associated with student 164 (such as a parent, grandparent, relative, guardian, and/or supporter of student 164), participant 168 in the given activity, person 170 associated with participant 168 (such as a parent, grandparent, relative, guardian, and/or supporter of participant 168), rider 172 in an equestrian activity that forms at least a portion of the given activity, person 174 associated with rider 172 (such as a parent, grandparent, relative, guardian, and/or supporter of rider 172), owner 176 of a horse that will participate in the equestrian activity, and/or person 178 associated with owner 176 (such as a parent, grandparent, relative, guardian, and/or supporter of owner 176).

Supply-side entity 180 may include and/or be any suitable person, group of people, and/or entity that may be associated with supply of one or more product and/or item from list of selected products 192 to customer 160. Examples of supply-side entity 180 include a marketer 184 of at least one item from the list of selected products, a manufacturer 186 of at least one item from the list of selected products, a distributor 188 of at least one item from the list of selected products, and/or a retailer 190 of at least one item from the list of selected products.

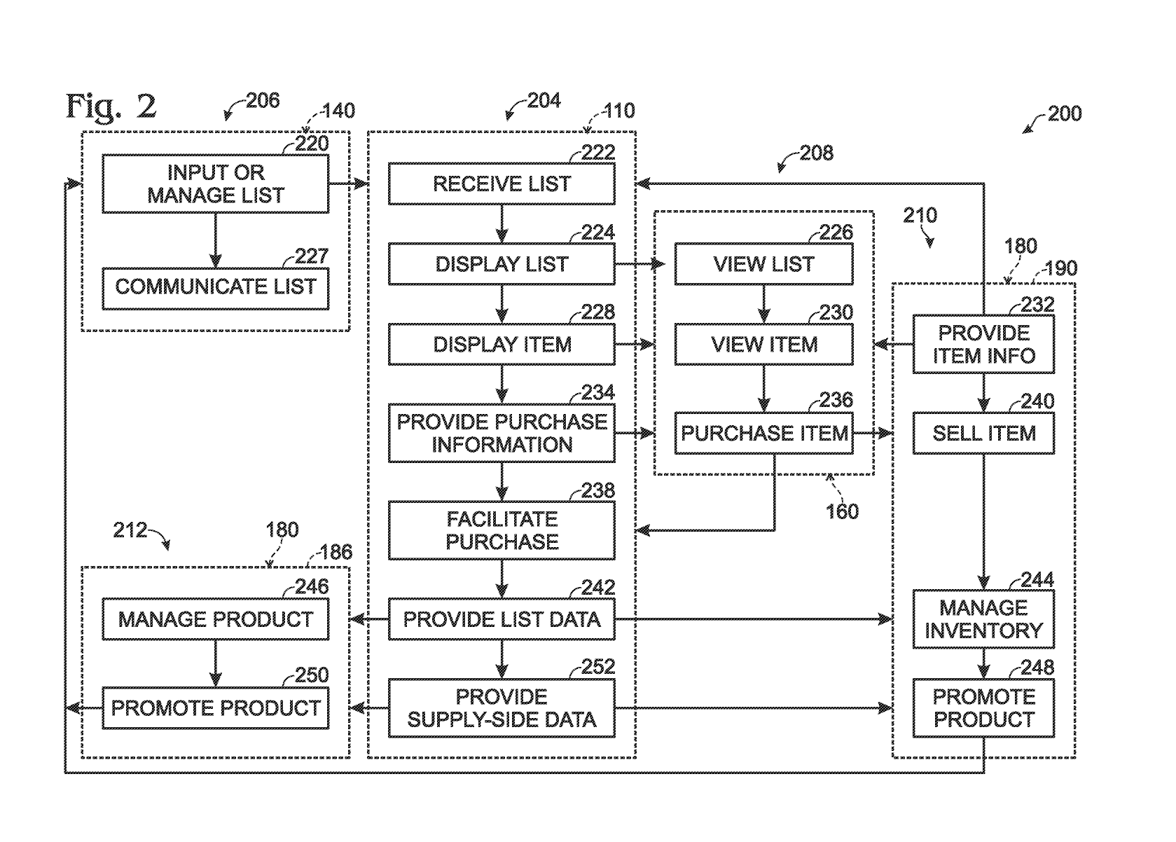

FIG. 2 generally and schematically illustrates examples of methods 200. Additionally or alternatively, FIG. 2 may be described as generally and schematically illustrating the optional flow of information amongst a list facilitator 110, influencers 140, customers 160, and/or supply-side entities 180 associated with systems 100 of FIG. 1. The flow chart schematically illustrates the general relationship between steps performed by one or more of the list facilitator, the influencer, the customer, and/or the supply-side entity, but such indications are not limiting in that such corresponding steps are not necessarily performed at a specific moment in time relative to other steps, and the relationships are depicted for illustrative purposes only.

Methods 200 according to the present disclosure may include one or more of a method 204 performed by list facilitator 110 and/or an associated computer or software, a method 206 performed by influencer 140 and/or an associated computer or software, a method 208 performed by customer 160 and/or an associated computer or software, a method 210 performed by a supply-side entity 180, such as a retailer 190 and/or an associated computer or software, and/or a method 212 performed by supply-side entity 180, such as a manufacturer 186 and/or an associated computer or software. Additionally or alternatively, a method 200 may include steps performed by more than one of the facilitator, the influencer, the customer, the retailer, and/or the manufacturer (or computers associated therewith).

Moreover, the various illustrated steps in FIG. 2 are not required for a given method 200, and methods 200 may include any suitable combination of the various optional steps illustrated in FIG. 2 and discussed herein. As used herein, reference to one or more of list facilitator 110, influencer 140, customer 160, and/or supply-side entity 180 inherently may include reference to an associated computer and/or software, such as may be operated by and/or under the control of a respective person or organization. For example, with reference to FIG. 2, a step 220, in which an influencer inputs and manages one or more lists associated with an activity, also may be described from the perspective of an associated computer as receiving a list from an influencer and/or as sending the list to list facilitator 110 or an associated computer thereof.

As mentioned, a method 200 may include a step 220 associated with influencer 140 inputting and managing one or more lists associated with one or more activities. Stated differently, a computer associated with the influencer may receive list data from the influencer and send this list data to list facilitator 110, as schematically represented in FIG. 2. Method 200 may include, and system 100 may be configured to permit, the list facilitator to identify the influencer, such as by the influencer being logged into a website or other user interface for entering list data. The influencer may create a new list from scratch (i.e., without basing it on an existing list). Alternatively, the influencer may search and/or otherwise view existing lists, may utilize an existing list, and/or may modify, edit, or otherwise customize an existing list. As examples, existing lists may be the influencer's existing lists, other influencers' existing lists, model/sample lists, and/or lists provided and/or proposed by the list facilitator and/or by the supply-side entity.

A step 222 associated with the list facilitator may include receiving the list data from the influencer. As an example, the list data may include one or more of the name of an equestrian event or show, categories of items required by participants in the event or show, and/or one or more specific items within one or more category. As another example, the list data for an influencer in the form of a coach or trainer may include one or more of the influencer's name, the location of the activity, the type of activity for which training will be given, the skill level of the activity, categories of items required by participants (i.e., individuals who will receive training or coaching), and one or more specific items within one or more of the categories. For each specific item, or type of item, the list data optionally may include data corresponding to variables for selection by the customer, required information, descriptions, product information, availability information (size, style, model, in-stock status, delivery time, etc.), and approved retailers and/or manufacturers. As more specific examples, list data corresponding to a particular product may include the specific model of the product that is required, a range of models, and/or styles that are acceptable to the influencer, and/or a description of characteristics that a selected product must possess to be acceptable to the influencer.

The list facilitator then may process the list data for display on a website, as schematically indicated at 224 in FIG. 2, at which website customer 160 may view the list data, as schematically indicated at 226 in FIG. 2. The influencer also may communicate a created list to others, as indicated at 227 in FIG. 2. For example, a created list for a particular activity may be shared, distributed, and/or otherwise communicated to participants (current, prospective, former, etc.) for the activity. Examples of such communication may include sending the list, or information about the list, via email, posting and/or linking to the list on one or more websites, sharing the list, or information about the list, via social media, etc. It is also within the scope of the present disclosure that the list facilitator, customer, or other party may perform this communication of one or more lists to others.

FIG. 3 provides an example of a webpage 260 that may be used with and/or form a portion of systems 100 and/or methods 200/300/400 according to the present disclosure. As illustrated, webpage 260 includes a title 262 of the activity and a list 264 associated with the activity and corresponding to the list data entered by the influencer. When viewing the list, the customer may be given the opportunity to select and/or view a specific item from the list, as schematically indicated at 228 and 230 in FIG. 2. In the example webpage of FIG. 3, a user has selected “boots” from the list 264 and more detailed information about the boots is provided at 266, such as including required and/or preferred versions of the boots as specified by the influencer. Additionally or alternatively, the information about the item may be provided by a retailer 190, as indicated at 232 in FIG. 2. For example, the list facilitator's website may retrieve this information in the background and display it on the webpage as illustrated in FIG. 3. Additionally or alternatively, the list facilitator's website may link directly to a retailer's website with the additional information associated with the item.

Although not required for all methods 200, in some methods, the customer may be given the opportunity to purchase the item as indicated at 234 and 236 in FIG. 2 and at 268 in FIG. 3. In some such methods, the list facilitator may facilitate the purchase of the item, as indicated at 238 in FIG. 2. For example, the list facilitator's website itself may facilitate the purchase of the item, such as via an e-commerce platform utilizing a shopping cart system. Alternatively, the website may link directly to at least one retailer's 190 website, at which website the customer may purchase the item directly from the retailer, as indicated at 240 in FIG. 2.

Additionally or alternatively, the list facilitator's website may be configured so that its own website information remains active in a region of the user's computer screen, while the retailer's website is provided in another region of the user's computer screen. In such an optional configuration, the customer may purchase a first item from the item list, and then select another item from the item list, which item may be offered by a different retailer, with the customer avoiding having to use the “back” button on his/her web browser or otherwise select another window or tab associated with his/her web browser. Moreover, after each item is purchased, the item list may communicate further information to the customer, such as by including a check mark next to the item, or otherwise indicating that the item has been purchased.

In some systems and methods, although not required, the list facilitator may be the retailer. In some systems and methods, the list facilitator may have preferred retailers that it utilizes to facilitate the sale of items to a customer. In some systems and methods, the influencer may have preferred retailers that it requests to be used by the list facilitator for all items on a list or for particular items on a list. In some systems and/or methods according to the present disclosure, the list facilitator may selectively negotiate or otherwise contract with retailers and/or manufacturers. For example, such negotiations and/or contracts may be for the retailer to be the first, most prominent, and/or only retailer listed for certain products, categories of products, and/or activities. Similarly, such negotiations and/or contracts may be for the manufacturer's products to be the first, most prominent, and/or only products listed for certain lists and/or product categories.

As a result of the example methods 200 discussed, an influencer can feel confident that customers are purchasing the required and/or preferred items associated with an activity. Similarly, a customer (and/or a customer's parents or other purchasing/funding party) can feel confident that he/she is purchasing the required and/or preferred items associated with an activity.

As schematically illustrated in FIG. 2, some methods 200 also include exchange of additional information between two or more of influencers, a list facilitator, retailers, and manufacturers. For example, as indicated at 242 in FIG. 2, the list facilitator may provide list data to supply-side entity 180, so that the supply-side entity can manage inventory and/or production of products based on expected needs by a particular community, such as customers in the equestrian riding industry, as indicated at 244 and 246. As another example, this list data may be utilized to generate sales margin information and/or estimates, such as for overall sales margins for an activity or series of activities, a participant, an average of a plurality of participants, etc. As a further example, the list data may be used to determine an estimate of future sales, demand, popularity (with influencers, customers, etc.), etc. As yet another example, and as indicated at 252, list facilitator 110 additionally or alternatively may provide supply-side data to one or more supply-side entities 180. Examples of supply-side data are discussed herein.

List data and/or supply-side data relating to customers and/or influencers may be utilized to promote a particular activity, retailer's product(s), and/or manufacturer's product(s), as indicated at 248 and 250 in FIG. 2. As examples, information about new products, rebates, incentives, discounts, and the like may be communicated based, at least in part, on the list data and/or on the supply-side data. Supply-side entities and/or influencers also may incorporate customer/participant loyalty programs into systems and methods according to the present disclosure.

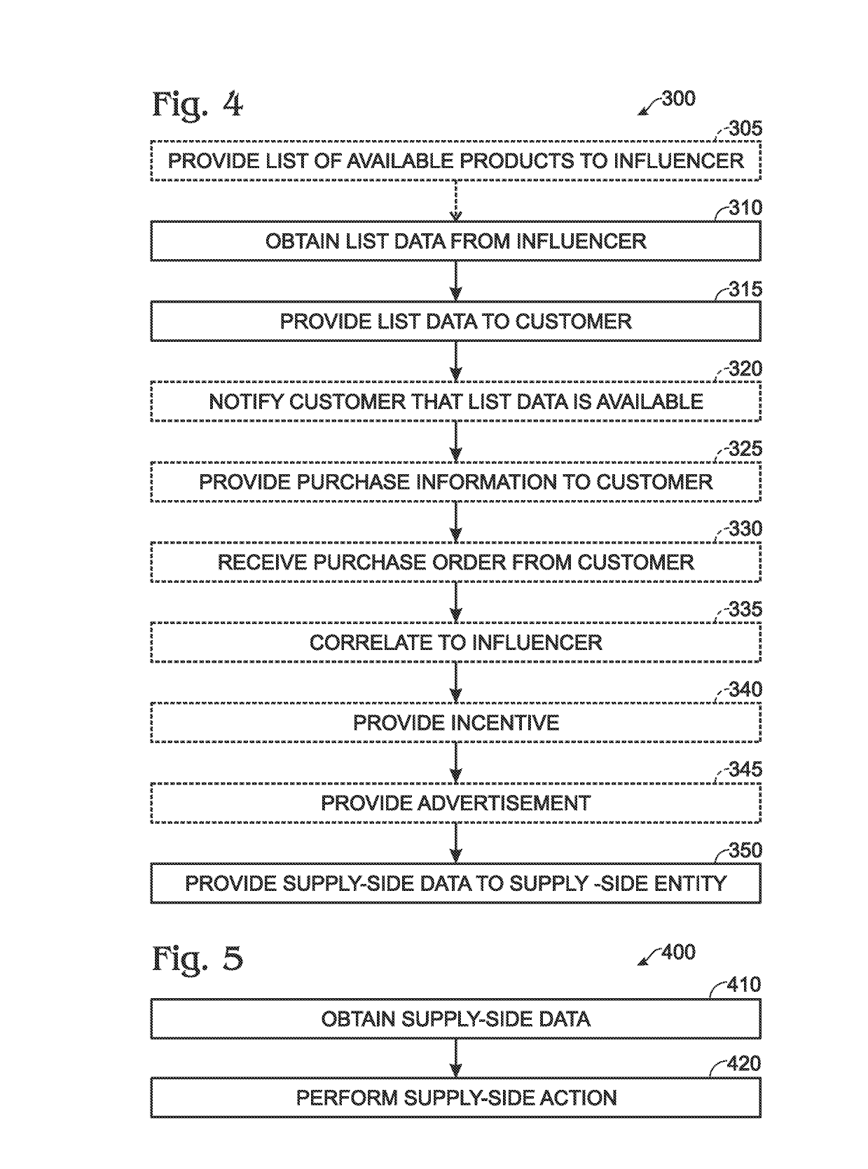

FIG. 4 is a flowchart depicting methods 300, according to the present disclosure, of coordinating information transfer among a plurality of entities. Methods 300 may include providing a list of available products to an influencer at 305 and include obtaining list data from the influencer at 310 and providing the list data to a customer at 315. Methods 300 further may include notifying the customer that the list data is available at 320, providing purchase information to the customer at 325, receiving a purchase order from the customer at 330, correlating to the influencer at 335, providing an incentive at 340, and/or providing an advertisement at 345. Methods 300 also include providing supply-side data to a supply-side entity at 350.

Providing the list of available products to the influencer at 305 may include providing any suitable list of products that may be available for purchase, sale, shipment, distribution, and/or manufacture and may be accomplished in any suitable manner. As an example, the providing at 305 may include providing an electronic output, which is indicative of the list of available products, to the influencer. Under these conditions, the providing at 305 further may include directly or indirectly transmitting the electronic output from a list facilitator to an electronic device that is associated with the influencer and/or that is configured to interact with the influencer.

As another example, the providing at 305 additionally or alternatively may include providing a hard copy of the list of available products to the influencer. Examples of the hard copy of the list of available products include a printed list, a catalog, and/or a printed catalog. Examples of the influencer are disclosed herein.

As discussed, the list of available products may include any suitable product and/or products. As an example, the list of available products may include and/or be a list of available equestrian equipment. As more specific examples, the list of available products may include a list of available parameters for at least one available product, a name of the at last one available product, a category of the at least one available product, a size (or size range) of the at least one available product, a style of the at least one available product, a model number of the at least one available product, a color of the at least one available product, and/or a design of the at least one available product.

Obtaining the list data from the influencer at 310 may include obtaining list data for a given activity from the influencer. The list data may include a list of selected products for the given activity that may be chosen, selected, and/or coordinated by the influencer, and the list of selected products may be a subset of the list of available products that may be provided to the influencer, such as during the providing at 305. As such, the list data may include information regarding which products (i.e., the list of selected products) and/or which products from the list of available products are recommended by the influencer, are recommended for the given activity, are acceptable to the influencer, are acceptable for the given activity, and/or may be utilized in and/or during the given activity.

The obtaining at 310 may be accomplished in any suitable manner. As an example, the obtaining at 310 may include obtaining an electronic input, which is indicative of the list data, from the influencer. Under these conditions, the obtaining at 310 further may include directly or indirectly obtaining the electronic input from an electronic device that is associated with the influencer and/or that is configured to interact with the influencer.

As another example, the obtaining at 310 additionally or alternatively may include obtaining a hard copy of the list data from the influencer. Examples of the hard copy of the list data include a printed list and/or a handwritten list.

As yet another example, the obtaining at 310 may include obtaining with the list facilitator. Examples of the list facilitator are disclosed herein. As additional examples, the obtaining at 310 may include actively obtaining, requesting, or procuring the list data from the influencer. Additionally or alternatively, the obtaining at 310 may include passively obtaining, receiving, and/or awaiting receipt of the list data from the influencer.

Providing the list data to the customer at 315 may include providing the list data for the given activity to the customer and may be accomplished in any suitable manner. As an example, the providing at 315 may include providing an electronic output, which is indicative of the list data, to the customer. Under these conditions, the providing at 315 further may include directly or indirectly transmitting the electronic output from the list facilitator to an electronic device that is associated with the customer and/or that is configured to interact with the customer.

As a more specific example, the providing at 315 may include publishing the list data and/or the list of selected products to a web page. Examples of the web page include any suitable retail sales web page, retail pass-through web page, and/or web page of (or managed by) the list facilitator.

As another more specific example, the providing at 315 additionally or alternatively may include displaying the list of selected products, such as to permit viewing of the displayed list of selected products by the customer. The displaying may include displaying the list of selected products on a display device, and the display device may form a portion of the electronic device that is associated with the customer.

As yet another more specific example, the providing at 315 additionally or alternatively may include providing a hard copy of the list of selected products to the customer. Examples of the hard copy of the list of selected products include a printed list of the selected products, a catalog of the list of selected products, and/or a printed catalog of the list of selected products.

The providing at 315 may be active or passive. As an example, the providing at 315 may include actively providing the list data to the customer, such as via actively transmitting the electronic output to the customer, transmitting the electronic output to the customer without the customer requesting the electronic output, distributing the hard copy of the list of selected products to the customer, and/or distributing the hard copy of the list of selected products to the customer without the customer requesting the hard copy. As another example, the providing at 315 may include passively providing the list data to the customer. This may include publishing the list data, making the list data available to the customer, and/or making the list data available for access by the customer.

Notifying the customer that the list data is available at 320 may include making the customer aware that the list data is available to and/or available for access by the customer. As examples, the notifying at 320 may include generating an email that is indicative of the list data being available for access by the customer, transmitting the email to the customer, and/or distributing a printed flier, which is indicative of the list data being available for access by the customer, to the customer.

Providing purchase information to the customer at 325 may include providing purchase information for at least one item from the list of selected products. The purchase information may be based, at least in part, on the list data and/or on the list of selected products and may be designed, selected, and/or configured to permit and/or facilitate purchase of one or more items from the list of selected products by the customer.

Receiving the purchase order from the customer at 330 may include receiving any suitable purchase order from the customer in any suitable manner. The purchase order may include a subset of the list of selected products for the given activity and/or may include those products from the list of selected products that have been selected and/or chosen by the customer (or for purchase by the customer).

As an example, the receiving at 330 may include receiving an electronic input, which is indicative of the purchase order, from the customer. Under these conditions, the electronic input may be transmitted by the electronic device that is associated with the customer and/or may be received by and/or with the list facilitator. As another example, the receiving at 330 additionally or alternatively may include receiving a hard copy of the purchase order from the customer. When methods 300 include the receiving at 330, methods 300 further may include delivering (or facilitating delivery of) at least one item to the customer. The at least one item that is delivered to the customer may be indicated in the purchase order and/or the delivering may be based, at least in part, on the purchase order.

Correlating to the influencer at 335 may include compiling and/or tracking which product(s) from the list of available products and/or from the list of selected products are recommended by the influencer, viewed by the customer responsive to receipt of the list data by the customer, and/or sold to the customer responsive to receipt of the list data by the customer. As an example, the correlating at 335 may include correlating the purchase order to the influencer and/or to an identity of the influencer. As additional examples, the correlating at 335 may include correlating the list data and/or the list of selected products to the influencer and/or to an identity of the influencer. As another example, the correlating at 335 may include correlating web site hits and/or views of a given product from the list of selected products to the influencer and/or to an identity of the influencer.

The correlating at 335 may be utilized to permit targeted and/or specific marketing of products to the customer and/or to the influencer. This is discussed in more detail herein with reference to methods 400 of FIG. 5. Additionally or alternatively, the correlating at 335 may be utilized to track the impact of a given influencer on sales of a given product to the customer.

Providing the incentive at 340 may include providing any suitable incentive in any suitable manner and/or based upon any suitable criteria. As an example, the providing at 340 may include providing a purchase discount to the customer and/or to the influencer. The purchase discount may be based, at least in part, on the purchase order, on the list data, and/or on the list of selected products.

Providing the advertisement at 345 may include providing any suitable advertisement based upon any suitable criteria. As an example, the providing at 345 may include providing the advertisement to the customer. As another example, the providing at 345 may include providing the advertisement to the influencer. The advertisement may be provided based, at least in part, on the purchase order from the customer, on the list data, on the list of selected products, and/or on the identity of the influencer.

The providing at 345 may be accomplished in any suitable manner. As an example, the providing at 345 may include transmitting the advertisement to the electronic device that is configured to interact with the customer and/or to the electronic device that is configured to interact with the influencer.

Providing the supply-side data to the supply-side entity at 350 may include providing any suitable supply-side data to any suitable supply-side entity. The supply-side data may be based, at least in part, on the influencer and/or on the list data.

The providing at 350 may be accomplished in any suitable manner. As an example, the providing at 350 may include directly or indirectly providing an electronic output, which is indicative of the supply-side data, to the supply-side entity. This may include transmitting the electronic output from the list facilitator to an electronic device that is associated with the supply-side entity and/or that is configured to interact with the supply-side entity. As additional examples, the providing at 350 may include publishing the supply-side data on a web page and/or displaying the supply-side data, such as on a display device that may form a portion of the electronic device that is associated with the supply-side entity. As another example, the providing at 350 additionally or alternatively may include providing a hard copy of the supply-side data to the supply-side entity.

The providing at 350 may be performed with any suitable frequency. As an example, the providing at 350 may include providing the supply-side data to the supply-side entity in real-time. As another example, the providing at 350 additionally or alternatively may include periodically supplying aggregate, compiled, and/or summarized supply-side data to the supply-side entity. Examples of the supply-side entity include a marketer, a manufacturer, a distributor, and/or a retailer of at least one item from the list of selected products and are discussed in more detail herein.

The supply-side data may include and/or be any suitable information and/or data that may be based, at least in part, on the influencer and/or on the list data. As examples, the supply-side data may include and/or be the list data, the list of selected products, the identity of the influencer, a summary of products purchased by one or more customers responsive to receipt of the list data by the one or more customers, and/or a summary of products viewed and/or considered by the one or more customers responsive to receipt of the list data by the one or more customers. As another example, the supply-side data may include inventory staging recommendations for the supply-side entity that may be based, at least in part, on the purchase order from the customer and/or on the list data. As yet another example, the supply-side data may include a manufacturing volume recommendation for the supply-side entity that may be based, at least in part, on the purchase order from the customer and/or on the list data. As another example, the supply-side data may include a sales estimate for the supply-side entity that may be based, at least in part, on the purchase order from the customer and/or on the list data.

FIG. 5 is a flowchart depicting methods 400, according to the present disclosure, of providing targeted information from a supply-side entity. Methods 400 include obtaining supply-side data at 410 and performing a supply-side action at 420.

Obtaining the supply-side data at 410 may include obtaining the supply-side data for a given activity from a list facilitator. The supply-side data may be based, at least in part, on an influencer and on list data that has been compiled by the influencer. The list data includes a list of selected products for a given activity. The list of selected products is recommended to a customer by the influencer, suggested to the customer by the influencer, and/or required of the customer by the influencer in order for the customer to participate in the given activity. Thus, the list data may be correlated to the influencer and/or to an identity of the influencer.

The obtaining at 410 may be accomplished in any suitable manner. As an example, the obtaining at 410 may include obtaining and/or receiving an electronic input, which is indicative of the supply-side data, from the list facilitator. This may include obtaining from an electronic device of the list facilitator. Additionally or alternatively, the receiving the electronic input also may include receiving with an electronic device that is associated with the supply-side entity and/or that is configured to interact with the supply-side entity. As another example, the obtaining at 410 additionally or alternatively may include obtaining a hard copy of the supply-side data from the list facilitator.

It is within the scope of the present disclosure that the obtaining at 410 may include actively obtaining the supply-side data. As examples, the obtaining at 410 may include requesting the supply-side data from the list facilitator and/or procuring the supply-side data from the list facilitator. Additionally or alternatively, the obtaining at 410 also may include passively obtaining the supply-side data. As examples, the obtaining at 410 may include receiving the supply-side data from the list facilitator and/or awaiting receipt of the supply-side data from the list facilitator.

Performing the supply-side action at 420 may include performing any suitable supply-side action. The supply-side action may be based, at least in part, on the supply-side data. Examples of the supply-side action include targeting a new product introduction to the influencer and/or to the customer, providing a discount to the influencer and/or to the customer, and/or providing product literature to the influencer and/or to the customer.

The performing at 420 further may be based, at least in part, on one or more additional criteria. As examples, the performing at 420 may be based upon prior supply-side data that is correlated to the influencer, prior sales that were generated by the influencer, a location of the influencer, and/or a location of the customer.

As a more specific example, the supply-side entity may include and/or be a marketing entity that markets one or more items from the list of selected products. Under these conditions, the performing at 420 may include targeting marketing material to the influencer and/or to the customer.

As another more specific example, the supply-side entity may include and/or be a manufacturer that manufactures one or more items from the list of selected products. Under these conditions, the performing at 420 may include adjusting manufacturing quantities of the at least one item by the manufacturer.

As yet another more specific example, the supply-side entity may include and/or be a distributor that distributes one or more items from the list of selected products. Under these conditions, the performing at 420 may include staging the at least one item at a location that is proximal to the influencer and/or to the customer.

As another more specific example, the supply-side entity may include and/or be a retailer that sells one or more items from the list of selected products. Under these conditions, the performing at 420 may include adjusting an inventory quantity for the at least one item.

Returning to FIG. 1, electronic devices 112, 142, 162, and/or 182 according to the present disclosure may include any suitable structure that may be adapted, configured, designed, constructed, and/or programmed to permit communication therebetween, to permit respective electronic inputs and/or electronic outputs to be conveyed therebetween, and/or to perform methods 200, 300, and/or 400, which are discussed in more detail herein. As examples, the electronic devices may include and/or be an electronic controller, a dedicated computer, a special-purpose computer, and/or a personal computer.

As a more specific example, and as illustrated in FIG. 1 with reference to electronic device 112 of list facilitator 110, one or more of the electronic devices 112, 142, 162, and/or 182 may include a communications framework 114. Communications framework 114 may provide communications between a processor unit 116, a memory 120, persistent storage 122, a communications unit 124, an input/output (I/O) unit 126, and/or a display 128. Memory 120, persistent storage 122, communications unit 124, input/output (I/O) unit 126, and display 128 are examples of resources accessible by processor unit 116 via communications framework 114.

Processor unit 116 serves to run instructions that may be loaded into memory 120. Processor unit 116 may include a number of processors, a multi-processor core, or some other type of processor, depending on the particular implementation. Further, processor unit 116 may be implemented using a number of heterogeneous processor systems in which a main processor is present with secondary processors on a single chip. As another example, processor unit 116 may be a symmetric multi-processor system containing multiple processors of the same type.

Memory 120 and persistent storage 122 are examples of data storage devices 118. A data storage device is any piece of hardware that is capable of storing information, such as, for example, without limitation, data, program code in functional form, and other suitable information either on a temporary basis or a permanent basis.

Data storage devices 118 also may be referred to herein as computer readable storage devices and/or as computer readable storage media 134 in these examples. Memory 120, in these examples, may be, for example, a random access memory or any other suitable volatile or non-volatile storage device. Persistent storage 122 may take various forms, depending on the particular implementation.

For example, persistent storage 122 may contain one or more components or devices. For example, persistent storage 122 may be a hard drive, a flash memory, a rewritable optical disk, a rewritable magnetic tape, or some combination of the above. The one or more components or devices used by persistent storage 122 also may be removable. For example, a removable hard drive may be used for persistent storage 122.

In the systems and methods according to the present disclosure, data storage devices 118, memory 120, persistent storage 122, and/or computer readable storage media 134 may store, or may be utilized to store, list of available products 191 and/or list data 193. Additionally or alternatively, data storage devices 118, memory 120, persistent storage 122, and/or computer readable storage media 134 may store, or may be utilized to store, information regarding the actions of influencer 140 and/or customer 160. Examples of this stored information may include click data regarding items that are selected by influencer 140 and/or customer 160, view data regarding items that are viewed by influencer 140 and/or customer 160, and/or sales logs regarding items that are purchased by influencer 140 and/or customer 160.

Communications unit 124, in these examples, provides for communications with other electronic devices. In these examples, communications unit 124 may be a network interface card. Communications unit 124 may provide communications through the use of either or both physical and wireless communications links.

Input/output (I/O) unit 126 allows for input and output of data with other devices that may be connected to electronic device 112. For example, input/output (I/O) unit 126 may provide a connection for user input through a keyboard, a mouse, and/or some other suitable input device. Further, input/output (I/O) unit 126 may send output to a printer and/or to display 128. Display 128 provides a mechanism to display information to a user.

Instructions for the operating system, applications, and/or programs may be located in data storage devices 118, which may be in communication with processor unit 116 through communications framework 114. The instructions may be in a functional form on persistent storage 122. These instructions may be loaded into memory 120 for execution by processor unit 116. The processes of the different embodiments may be performed by processor unit 116 using computer-implemented instructions, which may be located in a memory, such as memory 120.

These instructions are referred to as program instructions, a program code, computer usable program code, or computer readable program code that may be read and/or executed by a processor in processor unit 116. The program code in the different embodiments may be located, stored, and/or embodied on different physical or computer readable storage media, such as memory 120 or persistent storage 122.

The program code may be located in a functional form on computer readable media 132 that may be selectively removable and may be loaded onto or transferred to electronic device 112 for execution by processor unit 116. The program code and computer readable media 132 may form a computer program product in these examples. In one example, computer readable media 132 may be computer readable storage media 134 or computer readable signal media 136.

Computer readable storage media 134 may include, for example, an optical or magnetic disk that is inserted or placed into a drive or other device that is part of persistent storage 122 for transfer onto a storage device, such as a hard drive, that is part of persistent storage 122. Computer readable storage media 134 also may take the form of persistent storage, such as a hard drive, a thumb drive, or a flash memory, that is connected to electronic device 112. In some instances, computer readable storage media 134 may not be removable from electronic device 112.

Computer readable storage media 134 is a physical or tangible storage device used to store program code rather than a medium that propagates or transmits the program code. Computer readable storage media 134 is also referred to as a computer readable tangible storage device or a computer readable physical storage device. In other words, computer readable storage media 134 is a media that can be touched by a person.

Alternatively, the program code may be transferred to electronic device 112 using computer readable signal media 136. Computer readable signal media 136 may be, for example, a propagated data signal containing the program code. For example, computer readable signal media 136 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code may be downloaded over a network to persistent storage 122 from another device or data processing system through computer readable signal media 136 for use within electronic device 112. For instance, program code stored in a computer readable storage medium in a server data processing system may be downloaded over a network from the server to electronic device 112. The data processing system providing the program code may be a server computer, a client computer, or some other device capable of storing and transmitting the program code.

The different components illustrated for electronic device 112 are not meant to provide architectural limitations to the manner in which different embodiments may be implemented. The different illustrative embodiments may be implemented in a data processing system including components in addition to and/or in place of those illustrated for electronic device 112. Other components shown in FIG. 1 can be varied from the illustrative examples shown. The different embodiments may be implemented using any hardware device or system adapted, configured, designed, constructed, and or programmed to run the program code. As one example, electronic device 112 may include organic components integrated with inorganic components and/or may be comprised entirely of organic components excluding a human being. For example, a storage device may be comprised of an organic semiconductor.

In another example, processor unit 116 may take the form of a hardware unit that has circuits that are manufactured or configured for a particular use. This type of hardware may perform operations without needing program code to be loaded into a memory from a storage device to be configured to perform the operations.

For example, when processor unit 116 takes the form of a hardware unit, processor unit 116 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a field programmable logic array, a field programmable gate array, and other suitable hardware devices. With this type of implementation, the program code may be omitted, because the processes for the different embodiments are implemented and/or embedded in a hardware unit.

In still another example, processor unit 116 may be implemented using a combination of processors found in computers and hardware units. Processor unit 116 may have a number of hardware units and a number of processors that are configured to run the program code. With this example, some of the processes may be implemented and/or embedded in the number of hardware units, while other processes may be implemented in the number of processors.

In another example, a bus system may be used to implement communications framework 114 and may be comprised of one or more buses, such as a system bus or an input/output bus. Of course, the bus system may be implemented using any suitable type of architecture that provides for a transfer of data between different components or devices attached to the bus system.

Additionally, communications unit 124 may include a number of devices that transmit data, receive data, or both transmit and receive data. Communications unit 124 may be, for example, a modem or a network adapter, two network adapters, or some combination thereof. Further, communications unit 124 may include a memory that may be, for example, memory 120, or a cache, such as that found in an interface and memory controller hub that may be present in communications framework 114.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

Examples of systems and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

A1. A method of coordinating information transfer among a plurality of entities, the method comprising:

obtaining list data for a given activity from an influencer, wherein the list data includes a list of selected products for the given activity;

providing the list data for the given activity to a customer; and

providing supply-side data to a supply-side entity, wherein the supply-side data is based, at least in part, on the influencer and the list data.

A2. The method of paragraph A1, wherein the obtaining the list data includes obtaining an electronic input that is indicative of the list data from the influencer.

A3. The method of paragraph A2, wherein the obtaining the electronic input that is indicative of the list data from the influencer includes obtaining from an electronic device that is configured to interact with the influencer.

A4. The method of any of paragraphs A2-A3, wherein the obtaining the electronic input that is indicative of the list data from the influencer includes obtaining with a list facilitator.

A5. The method of any of paragraphs A1-A4, wherein the obtaining the list data includes obtaining a hard copy of the list data from the influencer.

A6. The method of any of paragraphs A1-A5, wherein the obtaining the list data includes actively obtaining, and optionally requesting, and further optionally procuring, the list data.

A7. The method of any of paragraphs A1-A6, wherein the obtaining the list data includes passively obtaining, and optionally receiving, and further optionally awaiting receipt of, the list data.

A8. The method of any of paragraphs A1-A7, wherein the method further includes providing a list of available products to the influencer.

A9. The method of paragraph A8, wherein the list of selected products includes a subset of the list of available products.

A10. The method of any of paragraphs A8-A9, wherein the providing the list of available products includes providing an electronic output that is indicative of the list of available products to the influencer.

A11. The method of paragraph A10, wherein the providing the electronic output that is indicative of the list of available products to the influencer includes transmitting from a/the list facilitator to an/the electronic device that is configured to interact with the influencer.

A12. The method of any of paragraphs A8-A11, wherein the providing the list of available products includes providing a hard copy of the list of available products to the influencer, optionally wherein the hard copy of the list of available products includes a catalog.

A13. The method of any of paragraphs A8-A12, wherein the list of available products includes a list of available equestrian equipment.

A14. The method of any of paragraphs A8-A13, wherein the list of available products includes at least one of:

a list of available parameters for at least one available product;

a name of at least one available product;

a category of at least one available product;

a size of at least one available product;

a style of at least one available product;

a model number of at least one available product;

a color of at least one available product;

a characteristic of at least one available product;

a feature of at least one available product; and

a design of at least one available product.

A15. The method of any of paragraphs A1-A14, wherein the providing the list data to the customer includes providing an electronic output that is indicative of the list data to the customer.

A16. The method of paragraph A15, wherein the providing the electronic output that is indicative of the list data to the customer includes transmitting from a/the list facilitator to an electronic device that is configured to interact with the customer.

A17. The method of any of paragraphs A1-A16, wherein the providing the list data to the customer includes publishing the list of selected products on a web page.

A18. The method of paragraph A17, wherein the web page includes at least one of a retail sales web page, a retail pass-through web page, and a web page of a/the list facilitator.

A19. The method of any of paragraphs A1-A18, wherein the providing the list data to the customer includes displaying the list of selected products, optionally wherein the displaying includes displaying on a display device, and further optionally wherein the display device forms a portion of an/the electronic device that is configured to interact with the customer.

A20. The method of any of paragraphs A1-A19, wherein the providing the list data to the customer includes providing a hard copy of the list of selected products to the customer.

A21. The method of any of paragraphs A1-A20, wherein the providing the list data to the customer includes making the list data available to, or available for access by, the customer.

A22. The method of paragraph A21, wherein the method further includes notifying the customer that the list data is available to the customer.

A23. The method of any of paragraphs A1-A22, wherein the providing the supply-side data to the supply-side entity includes providing an electronic output that is indicative of the supply-side data to the supply-side entity.

A24. The method of paragraph A23, wherein the providing the electronic output that is indicative of the supply-side data to the supply-side entity includes transmitting from a/the list facilitator to an electronic device that is configured to interact with the supply-side entity.

A25. The method of any of paragraphs A1-A24, wherein the providing the supply-side data to the supply-side entity includes publishing the supply-side data on a web page.

A26. The method of any of paragraphs A1-A25, wherein the providing the supply-side data to the supply-side entity includes displaying the supply-side data, optionally wherein the displaying includes displaying on a display device.

A27. The method of any of paragraphs A1-A26, wherein the providing the supply-side data to the supply-side entity includes providing a hard copy of the supply-side data to the supply-side entity.

A28. The method of any of paragraphs A1-A27, wherein the providing the supply-side data to the supply-side entity includes at least one of:

(i) providing the supply-side data in real-time; and

(ii) periodically supplying aggregate supply-side data.

A29. The method of any of paragraphs A1-A28, wherein the method further includes providing purchase information to the customer for at least one item, wherein the providing purchase information is based, at least in part, on the list data.

A30. The method of any of paragraphs A1-A29, wherein the method further includes receiving a purchase order from the customer, wherein the purchase order includes a subset of the list of selected products for the given activity.

A31. The method of paragraph A30, wherein the receiving the purchase order from the customer includes receiving an electronic input that is indicative of the purchase order from the customer.

A32. The method of paragraph A31, wherein the receiving the electronic input that is indicative of the purchase order from the customer includes receiving with a/the list facilitator.

A33. The method of any of paragraphs A30-A32, wherein the receiving the purchase order from the customer includes receiving a hard copy of the purchase order from the customer.

A34. The method of any of paragraphs A30-A33, wherein the method further includes correlating the purchase order from the customer to the influencer.

A35. The method of any of paragraphs A30-A34, wherein the method further includes facilitating delivery of at least one item to the customer based, at least in part, on the purchase order.

A36. The method of any of paragraphs A1-A35, wherein the method further includes providing a purchase discount to the influencer, wherein the purchase discount is based, at least in part, on a/the purchase order from the customer.

A37. The method of any of paragraphs A1-A36, wherein the method further includes providing a/the purchase discount to the influencer, wherein the discount is based, at least in part, on the list data.

A38. The method of any of paragraphs A1-A37, wherein the method further includes providing an advertisement to the customer, wherein the advertisement is based, at least in part, on a/the purchase order from the customer.

A39. The method of any of paragraphs A1-A38, wherein the method further includes providing an/the advertisement to the customer, wherein the advertisement is based, at least in part, on the list data.

A40. The method of any of paragraphs A1-A39, wherein the method further includes providing an/the advertisement to the influencer, wherein the advertisement is based, at least in part, on the list data.

A41. The method of any of paragraphs A38-A40, wherein the providing the advertisement includes transmitting the advertisement to an/the electronic device that is configured to interact with the customer.

A42. The method of any of paragraphs A1-A41, wherein the providing the supply-side data includes providing an inventory staging recommendation to the supply-side entity, wherein the inventory staging recommendation is based, at least in part, on a/the purchase order from the customer.

A43. The method of any of paragraphs A1-A42, wherein the providing the supply-side data includes providing an/the inventory staging recommendation to the supply-side entity, wherein the inventory staging recommendation is based, at least in part, on the list data.

A44. The method of any of paragraphs A42-A43, wherein the providing the inventory staging recommendation includes transmitting the inventory staging recommendation from a/the list facilitator to an/the electronic device that is configured to interact with the supply-side entity.

A45. The method of any of paragraphs A1-A44, wherein the providing the supply-side data includes providing a manufacturing volume recommendation to the supply-side entity, wherein the manufacturing volume recommendation is based, at least in part, on a/the purchase order from the customer.

A46. The method of any of paragraphs A1-A45, wherein the providing the supply-side data includes providing a/the manufacturing volume recommendation to the supply-side entity, wherein the manufacturing volume recommendation is based, at least in part, on the list data.

A47. The method of any of paragraphs A45-A46, wherein the providing the manufacturing volume recommendation includes transmitting the manufacturing volume recommendation from a/the list facilitator to an/the electronic device that is configured to interact with the supply-side entity.

A48. The method of any of paragraphs A1-A47, wherein the providing the supply-side data includes providing a sales estimate to the supply-side entity, wherein the sales estimate is based, at least in part, on a/the purchase order from the customer, and optionally wherein the method further includes correlating the sales estimate to the influencer.

A49. The method of any of paragraphs A1-A48, wherein the providing the supply-side data includes providing a/the sales estimate to the supply-side entity, wherein the sales estimate is based, at least in part, on the list data, and optionally wherein the method further includes correlating the sales estimate to the influencer.

A50. The method of any of paragraphs A48-A49, wherein the providing the sales estimate includes transmitting the sales estimate from a/the list facilitator to an/the electronic device that is configured to interact with the supply-side entity.

B1. A list facilitator, comprising:

an electronic device programmed to perform the method of any of paragraphs A1-A50.

B2. The list facilitator of paragraph B1, wherein the list facilitator includes at least one of, and optionally at least two of, and further optionally a plurality or multiplicity of:

(i) a communications framework;

(ii) a processor unit;

(iii) a data storage device;

(iv) memory;

(v) persistent storage;

(vi) a communications unit;

(vii) an input/output unit;

(viii) a display;

(ix) a storage device;

(x) computer readable media;

(xi) computer readable storage media; and

(xii) computer readable signal media.

B3. The list facilitator of any of paragraphs B1-B2, wherein the list facilitator is programmed to execute program code.

B4. The list facilitator of any of paragraphs B1-B3, wherein the electronic device includes at least one of an electronic controller, a dedicated computer, a special-purpose computer, and a personal computer.

B5. Computer readable storage medium including computer-executable instructions that, when executed, direct a list facilitator to perform the method of any of paragraphs A1-A50.

C1. A method of providing targeted information from a supply-side entity, the method comprising:

obtaining supply-side data for a given activity from a list facilitator, wherein the supply-side data is based, at least in part, on an influencer and on list data that is compiled by the influencer, wherein the list data includes a list of selected products for a given activity that is recommended to a customer by the influencer; and

performing a supply-side action based, at least in part, on the supply-side data.

C2. The method of paragraph C1, wherein the obtaining the supply-side data includes obtaining an electronic input that is indicative of the supply-side data from the list facilitator.

C3. The method of paragraph C2, wherein the obtaining the electronic input that is indicative of the supply-side data from the list facilitator includes obtaining from an electronic device of the list facilitator.

C4. The method of any of paragraphs C2-C3, wherein the obtaining the electronic input that is indicative of the supply-side data from the influencer includes obtaining with an electronic device that is configured to interact with the supply-side entity.

C5. The method of any of paragraphs C1-C4, wherein the obtaining the supply-side data includes obtaining a hard copy of the supply-side data from the list facilitator.

C6. The method of any of paragraphs C1-C5, wherein the obtaining the supply-side data includes actively obtaining, and optionally requesting, and further optionally procuring, the supply-side data.

C7. The method of any of paragraphs C1-C6, wherein the obtaining the supply-side data includes passively obtaining, and optionally receiving, and further optionally awaiting receipt of, the supply-side data.

C8. The method of any of paragraphs C1-C7, wherein the performing a supply-side action includes targeting a new product introduction to at least one of the influencer and the customer.

C9. The method of any of paragraphs C1-C8, wherein the performing a supply-side action includes providing a product discount to at least one of the influencer and the customer.

C10. The method of any of paragraphs C1-C9, wherein the performing a supply-side action includes providing product literature to at least one of the influencer and the customer.

C11. The method of any of paragraphs C1-C10, wherein the performing a supply-side action is further based, at least in part, on prior supply-side data that is correlated to the influencer.

C12. The method of any of paragraphs C1-C11, wherein the performing a supply-side action is further based, at least in part, on prior sales generated by the influencer.

C13. The method of any of paragraphs C1-C12, wherein the performing a supply-side action is further based, at least in part, on a location of at least one of the influencer and the customer.

C14. The method of any of paragraphs C1-C13, wherein the obtaining the supply-side data includes obtaining by a marketing entity, and further wherein the performing a supply-side action includes targeting marketing material to at least one of the influencer and the customer.

C15. The method of any of paragraphs C1-C14, wherein the obtaining the supply-side data includes obtaining by a manufacturer, wherein the list of selected products includes at least one item manufactured by the manufacturer, and further wherein the performing a supply-side action includes adjusting manufacturing quantities of the at least one item manufactured by the manufacturer.

C16. The method of any of paragraphs C1-C15, wherein the obtaining the supply-side data includes obtaining by a distributor, wherein the list of selected products includes at least one item distributed by the distributor, and further wherein the performing a supply-side action includes staging the at least one item distributed by the distributor at a location that is proximal to at least one of the influencer and the customer.

C17. The method of any of paragraphs C1-C16, wherein the obtaining the supply-side data includes obtaining by a retailer, wherein the list of selected products includes at least one item sold by the retailer, and further wherein the performing a supply-side action includes adjusting an inventory quantity of the at least one item.

D1. The method of any of paragraphs A1-A50 or C1-C17, wherein the influencer is different from the customer.

D2. The method of any of paragraphs A1-A50 or C1-D1, wherein the influencer is different from the supply-side entity.

D3. The method of any of paragraphs A1-A50 or C1-D2, wherein the customer is different from the supply-side entity.

D4. The method of any of paragraphs A1-A50 or C1-D3, wherein the influencer includes at least one of:

(i) an activity leader for the given activity;

(ii) a coordinator for the given activity;

(iii) an expert on the given activity;

(iv) a coach for the given activity;

(v) an instructor for the given activity;

(vi) an activity manager for the given activity; and

(vii) a rules body for the given activity.

D5. The method of any of paragraphs A1-A50 or C1-D4, wherein the given activity includes an equestrian activity, and further wherein the influencer includes a trainer associated with the customer.

D6. The method of any of paragraphs A1-A50 or C1-D5, wherein the given activity includes an/the equestrian activity, and further wherein the influencer includes a barn manager associated with the customer.

D7. The method of any of paragraphs A1-A50 or C1-D6, wherein the given activity includes an/the equestrian activity, and further wherein the influencer includes an/the equestrian club manager of an equestrian club associated with the customer.

D8. The method of any of paragraphs A1-A50 or C1-D7, wherein the customer includes a customer of the supply-side entity.

D9. The method of any of paragraphs A1-A50 or C1-D8, wherein the customer includes a consumer.

D10. The method of any of paragraphs A1-A50 or C1-D9, wherein the customer includes a purchaser.

D11. The method of any of paragraphs A1-A50 or C1-D10, wherein the customer includes a student, optionally a student of the influencer, and further optionally an equestrian student of the influencer.

D12. The method of any of paragraphs A1-A50 or C1-D11, wherein the customer includes a person associated with a/the student, and optionally wherein the person associated with the student includes at least one of a parent of the student, a guardian of the student, a supporter of the student, and a relative of the student.

D13. The method of any of paragraphs A1-A50 or C1-D12, wherein the customer includes a participant in the given activity.

D14. The method of any of paragraphs A1-A50 or C1-D13, wherein the customer includes a person associated with a/the participant in the given activity, optionally wherein the person associated with the participant in the given activity includes at least one of a parent of the participant, a supporter of the participant, and a relative of the participant.

D15. The method of any of paragraphs A1-A50 or C1-D14, wherein the given activity includes an/the equestrian activity, and further wherein the customer includes a rider in the equestrian activity.

D16. The method of any of paragraphs A1-A50 or C1-D15, wherein the given activity includes an/the equestrian activity, and further wherein the customer includes a person associated with a/the rider in the equestrian activity, optionally wherein the person associated with the rider in the equestrian activity includes at least one of a parent of the rider, a guardian of the rider, a supporter of the rider, and a relative of the rider.

D17. The method of any of paragraphs A1-A50 or C1-D16, wherein the given activity includes an/the equestrian activity, and further wherein the customer includes an owner of a horse that will participate in the equestrian activity.

D18. The method of any of paragraphs A1-A50 or C1-D17, wherein the given activity includes an/the equestrian activity, and further wherein the customer includes a person associated with a/the owner of a/the horse that will participate in the equestrian activity, optionally wherein the person associated with the owner of the horse includes at least one of a parent of the owner of the horse, a guardian of the owner of the horse, a supporter of the owner of the horse, and a relative of the owner of the horse.

D19. The method of any of paragraphs A1-A50 or C1-D18, wherein the activity includes an/the equestrian activity.

D20. The method of any of paragraphs A1-A50 or C1-D19, wherein the list of selected products includes a list of equestrian equipment.

D21. The method of any of paragraphs A1-A50 or C1-D20, wherein the list of selected products includes at least one of:

a list of acceptable parameters for at least one of the selected products;

a name of at least one of the selected products;

a category of at least one of the selected products;

a size of at least one of the selected products;

a selected style of at least one of the selected products;

a selected model number of at least one of the selected products;

a selected color of at least one of the selected products; and

a selected design of at least one of the selected products.

D22. The method of any of paragraphs A1-A50 or C1-D21, wherein the list data includes information regarding the given activity.

D23. The method of any of paragraphs A1-A50 or C1-D22, wherein the list data defines a location of the given activity.

D24. The method of any of paragraphs A1-A50 or C1-D23, wherein the list data includes an identity of the influencer.

D25. The method of any of paragraphs A1-A50 or C1-D24, wherein the method further includes correlating the list data to the influencer.

D26. The method of any of paragraphs A1-A50 or C1-D25, wherein the list facilitator includes an electronic device.

D27. The method of any of paragraphs A1-A50 or C1-D26, wherein the supply-side data includes at least one of:

(i) an identity of the influencer;

(ii) the list of selected products;

(iii) sales of at least one product from the list of selected products generated by the list of selected products;

(iv) web site hits generated by the list of selected products for at least one product from the list of selected products;

(v) sales of at least one product from the list of selected products generated by the influencer;

(vi) web site hits generated by the influencer for at least one product from the list of selected products.

(vii) related sales of at least one product generated by the influencer;

(viii) web site hits for at least one related product generated by the influencer;

(ix) related sales of at least one product generated by the list of selected products;

(x) web site hits for at least one related product generated by the list of selected products;

(xi) a cross-correlation of the list data; and

(xii) anonymized data.

D28. The method of any of paragraphs A1-A50 or C1-D27, wherein the supply-side data is correlated based upon, or to, an/the identity of the influencer.

### INDUSTRIAL APPLICABILITY

The systems and methods disclosed herein are applicable to the retail sales and marketing industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A method of coordinating information transfer among a plurality of entities, the method comprising:
obtaining list data for an equestrian activity from an influencer, wherein the list data includes a list of equestrian equipment for the equestrian activity;
providing the list data for the equestrian activity to a customer; and
providing supply-side data to a supply-side entity, wherein the supply-side data is based, at least in part, on the influencer and the list data.

2. The method of claim 1, wherein the obtaining the list data includes obtaining an electronic input that is indicative of the list data from the influencer, wherein the obtaining the electronic input that is indicative of the list data from the influencer includes obtaining from an electronic device that is configured to interact with the influencer.

3. The method of claim 1, wherein the method further includes providing a list of available products to the influencer, wherein the list of equestrian equipment includes a subset of the list of available products.

4. The method of claim 3, wherein the providing the list of available products includes providing an electronic output that is indicative of the list of available products to the influencer, wherein the providing the electronic output that is indicative of the list of available products to the influencer includes transmitting from a list facilitator to an electronic device that is configured to interact with the influencer.

5. The method of claim 3, wherein the list of available products includes at least one of:
a list of available parameters for at least one available product;
a name of at least available product;
a category of at least one available product;
a size of at least one available product;
a style of at least one available product;
a model number of at least one available product;
a color of at least one available product; and
a design of at least one available product.

6. The method of claim 1, wherein the providing the list data to the customer includes providing an electronic output that is indicative of the list data to the customer, wherein the providing the electronic output that is indicative of the list data to the customer includes transmitting from a list facilitator to an electronic device that is configured to interact with the customer.

7. The method of claim 1, wherein the providing the supply-side data to the supply-side entity includes providing an electronic output that is indicative of the supply-side data to the supply-side entity, wherein the providing the electronic output that is indicative of the supply-side data to the supply-side entity includes transmitting from a list facilitator to an electronic device that is configured to interact with the supply-side entity.

8. The method of claim 1, wherein the method further includes providing purchase information to the customer for at least one item, wherein the providing purchase information is based, at least in part, on the list data.

9. The method of claim 1, wherein the method further includes receiving a purchase order from the customer, wherein the purchase order includes a subset of the list of equestrian equipment for the equestrian activity, wherein the receiving the purchase order from the customer includes receiving an electronic input that is indicative of the purchase order from the customer.

10. The method of claim 9, wherein the receiving the electronic input that is indicative of the purchase order from the customer includes receiving with a list facilitator.

11. The method of claim 9, wherein the method further includes correlating the purchase order from the customer to the influencer.

12. The method of claim 9, wherein the method further includes facilitating delivery of at least one item to the customer based, at least in part, on the purchase order.

13. The method of claim 9, wherein the method further includes providing an advertisement to the customer, wherein the advertisement is based, at least in part, on at least one of the purchase order from the customer and the list data.

14. The method of claim 9, wherein the method further includes providing an advertisement to the influencer, wherein the advertisement is based, at least in part, on at least one of the purchase order from the customer and the list data.

15. The method of claim 1, wherein the influencer includes at least one of:
(i) an activity leader for the equestrian activity;
(ii) a coordinator for the equestrian activity;
(iii) an expert on the equestrian activity;
(iv) a coach for the equestrian activity;
(v) an instructor for the equestrian activity;
(vi) an activity manager for the equestrian activity; and
(vii) a rules body for the equestrian activity.

16. A method of providing targeted information from a supply-side entity for equestrian equipment, the method comprising:
obtaining supply-side data for an equestrian activity from a list facilitator, wherein the supply-side data is based, at least in part, on an influencer and on list data that is compiled by the influencer, wherein the list data includes a list of equestrian equipment, for an equestrian activity, that is recommended to a customer by the influencer; and
performing a supply-side action based, at least in part, on the supply-side data.

17. The method of claim 16, wherein the obtaining the supply-side data includes obtaining an electronic input that is indicative of the supply-side data from the list facilitator, wherein the obtaining the electronic input that is indicative of the supply-side data from the list facilitator includes obtaining from an electronic device of the list facilitator with an electronic device that is configured to interact with the supply-side entity.

18. The method of claim 16, wherein the performing a supply-side action includes at least one of:
(i) targeting a new product introduction to at least one of the influencer and the customer;
(ii) providing a product discount to at least one of the influencer and the customer; and
(iii) providing product literature to at least one of the influencer and the customer.

19. The method of claim 16, wherein the supply-side data includes at least one of:
(i) an identity of the influencer;
(ii) the list of equestrian equipment;
(iii) sales of at least one product from the list of equestrian equipment generated by the list of equestrian equipment;
(iv) web site hits generated by the list of equestrian equipment for at least one product from the list of equestrian equipment;
(v) sales of at least one product from the list of equestrian equipment generated by the influencer;
(vi) web site hits generated by the influencer for at least one product from the list of equestrian equipment.
(vii) related sales of at least one product generated by the influencer;
(viii) web site hits for at least one related product generated by the influencer;
(ix) related sales of at least one product generated by the list of equestrian equipment; and
(x) web site hits for at least one related product generated by the list of equestrian equipment.

20. The method of claim 16, wherein the influencer includes at least one of:
(i) an activity leader for the equestrian activity;
(ii) a coordinator for the equestrian activity;
(iii) an expert on the equestrian activity;
(iv) a coach for the equestrian activity;
(v) an instructor for the equestrian activity;
(vi) an activity manager for the equestrian activity; and
(vii) a rules body for the equestrian activity.
